(19) United States
(12) Patent Application Publication
(10) Pub. No.: US 2025/0195324 A1
(43) Pub. Date: Jun. 19, 2025

(54) TELESCOPING-PATTING INTEGRATED MASSAGER

(71) Applicants: Jiafeng Chen, Teng (CN); Yuhong Chen, Hanzhong (CN)

(72) Inventors: Jiafeng Chen, Teng (CN); Yuhong Chen, Hanzhong (CN)

(21) Appl. No.: 19/000,615

(22) Filed: Dec. 23, 2024

(51) Int. Cl. A61H 23/00; A61H 19/00; A61H 23/02

(52) U.S. Cl. CPC A61H 23/006; A61H 23/0254; A61H 19/44; A61H 2201/0157; A61H 2201/1215

(57) ABSTRACT

Disclosed is a telescoping-patting integrated massager. The telescoping-patting integrated massager comprises a housing and a soft rubber sleeve fitted on the housing, wherein the soft rubber sleeve is provided with a beating portion, a patting portion and a retracting portion; a main board and a telescoping driver electrically connected to the main board are arranged in the housing; a telescopic head of the telescoping driver is connected with a telescopic bracket; a fixed frame is arranged at one end of the housing; the beating head is embedded in the beating portion; the patting arm is embedded in the patting portion. The present disclosure is capable of doing patting massage and beating massage, thereby presenting double massage effect and enhancing the massage effect.

### BACKGROUND OF THE INVENTION

### Technical Field

The present disclosure relates to the technical fields of massagers and, in particular, to a telescoping-patting integrated massager.

### Description of Related Art

Massage is a method of achieving health care, cheerful mood and excitement through direct action on an object, and is growing rapidly in the commercial market. Among many massage products, the patting type is one of the important massage products. For its massage effect and the stimulation on the massaged part, the patting massage is hardly replaced by other massage manipulations.

In existing massage products, there are many ways to implement the contact massage mode, which can be considered as patting massage or an extension of the patting massage mode. For example, an eccentric vibrating motor is arranged on the main body of a massager, and an inertial eccentric gear is driven by the motor to rotate, thereby driving a housing of the main body of the massager to vibrate. The impact on the massaged object during vibration can form a certain patting feeling, but this kind of patting generally has a high frequency but low amplitude and insufficient intensity. In particular, if an in-body massager or a skin-contact massager is used, the vibrating/patting effect of the massager will be significantly reduced when it is used with a certain force against the skin or in-body. Moreover, when a vibrating massager simulates a patting effect, it is usually the massager body (housing) that vibrates as a whole. The vibration generally comes from the counter-acting force of the vibration caused by the inertia of the motor and cams inside the housing. The housing vibrating mode forms indiscriminate vibration patting. There is no solution for the patting stimulation effect on a certain part of the body.

### BRIEF SUMMARY OF THE INVENTION

In view of the shortcomings of the prior art, an objective of the present disclosure is to provide a telescoping-patting integrated massager.

In order to achieve the above objective, the present disclosure adopts the following technical solution:

A telescoping-patting integrated massager, comprising a housing and a soft rubber sleeve fitted on the housing, wherein the soft rubber sleeve is provided with a beating portion, a patting portion and a retracting portion; a main board and a telescoping driver electrically connected to the main board are arranged in the housing; a telescopic head of the telescoping driver is connected with a telescopic bracket, and the telescopic bracket is sleeved on the housing so that the telescopic bracket reciprocates in the same direction under the action of the telescoping driver; a fixed frame is arranged at one end of the housing; a mounting notch is provided on the telescopic bracket, a patting rod is hingedly mounted in the mounting notch, one end of the patting rod forms a patting arm, and the other end of the patting rod is connected to the fixed frame by a collar; a top end of the telescopic bracket is connected with a beating head, and the beating head is embedded in the beating portion; the patting arm is embedded in the patting portion; the retracting portion is located at a movement track of the telescopic bracket.

Preferably, when two or more patting rods are provided, the patting rods are arranged in a circular array on the telescopic bracket.

Preferably, the patting arm of the patting rod is a single-sided rod or a double-sided rod.

Preferably, when the patting arm is a single-sided rod, the patting arm is oriented upward or downward.

Preferably, a surface of the patting portion is provided with outwardly protruding patting bumps.

Preferably, the thickness of the retracting portion is less than the thickness of a main body of the soft rubber sleeve, and the retracting portion is ripple-like, wavelike or pleated to increase the ductility and elasticity of the retracting portion.

Preferably, the fixed frame is located at the middle part of the telescopic bracket, slide grooves are provided on the fixed frame, side plates of the telescopic bracket are respectively placed in the slide grooves, and the soft rubber sleeve is provided with a patting movement chamber corresponding to the patting portion.

Preferably, a vibrating motor is mounted in the beating head and electrically connected to the main board.

Preferably, a gripping portion for the user to grip is formed on the housing, and the gripping portion is composed of a boss for the thumb to press and an arc-shaped surface for the palm to grip.

Preferably, the housing is internally equipped with a battery and a key arranged on the main board, the battery is electrically connected with the main board, and a press portion of the key leans against the inner wall of the soft rubber sleeve; the battery is a rechargeable battery, the housing is provided with a charging contact, and the soft rubber sleeve is provided with an avoidance position corresponding to the charging contact.

Based on the above solution, the present disclosure uses the telescoping driver as a main power to simulates a high-speed and continuous patting action by means of the linkage of the telescopic drive, the fixing bracket and the patting rod, thereby quickly relieving muscle fatigue. Moreover, when in use, the massager can apply the massage force to a certain part to enhance the massage intensity, and especially for in-body massage, can provide better massage stimulation. Moreover, the beating head arranged in the beating portion follows the telescopic bracket to do a reciprocating telescopic movement, so as to simulate the beating massage action. In this way, the massager not only can work in a patting mode, but also can do beating massage during the patting massage, thereby presenting a double massage effect and further improving the in-body massage effect.

### BRIEF DESCRIPTION OF THE SEVERAL VIEWS OF THE DRAWINGS

FIG. 1 is a schematic structural diagram of an embodiment of the present disclosure.

FIG. 2 is an exploded diagram of an embodiment of the present disclosure.

FIG. 3 is a schematic structural diagram of a telescopic bracket in an embodiment of the present disclosure.

FIG. 4 is a schematic structural diagram of another type of patting rod in an embodiment of the present disclosure.

FIG. 5 is a schematic structural diagram of a double-sided patting arm in an embodiment of the present disclosure.

### DETAILED DESCRIPTION OF THE INVENTION

In order to make the objective, technical solution and advantages of the present disclosure more clearly understood, the present disclosure is further described in detail in combination with the accompanying drawings and embodiments. It should be understood that the specific embodiments described herein are only intended to explain the present disclosure but not to define the present disclosure.

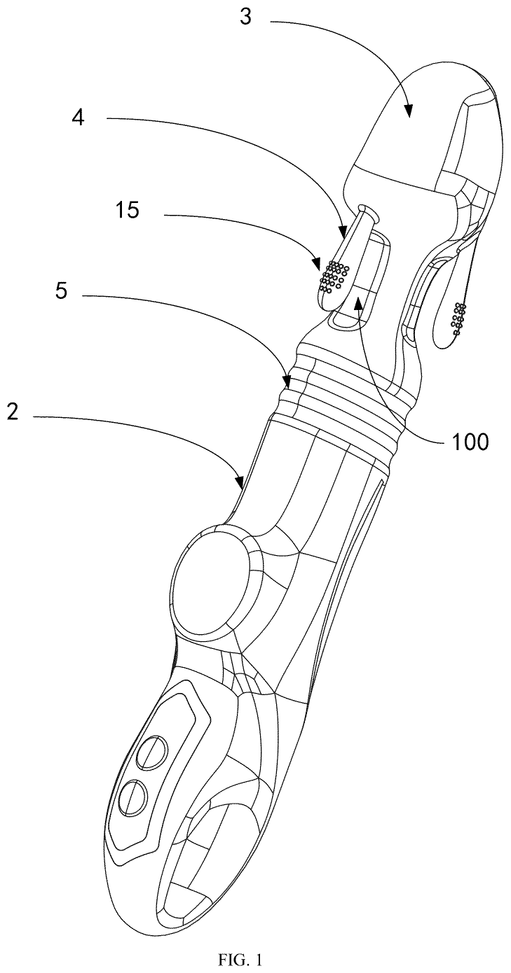

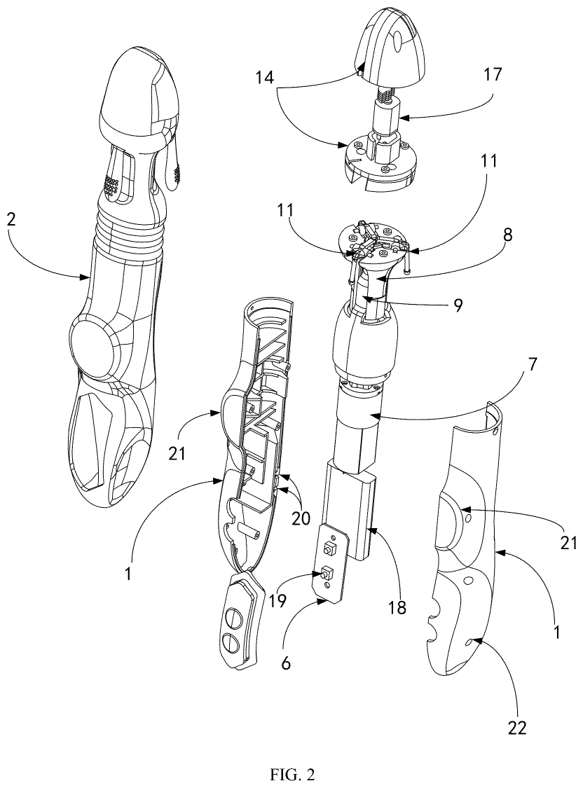

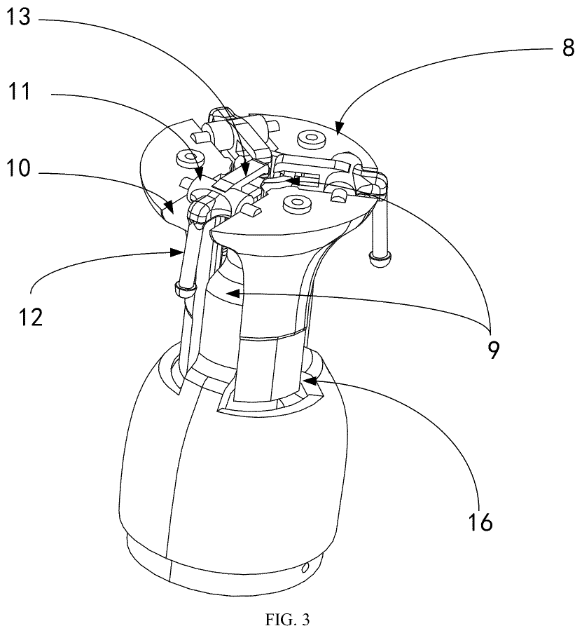

As shown in FIGS. 1-5, this embodiment provides a telescoping-patting integrated massager, comprising a housing 1 and a soft rubber sleeve 2 fitted on the housing 1, wherein the soft rubber sleeve 2 is provided with a beating portion 3, a patting portion 4 and a retracting portion 5; a main board 6 and a telescoping driver 7 electrically connected to the main board 6 are arranged in the housing 1; a telescopic head of the telescoping driver 7 is connected with a telescopic bracket 8, and the telescopic bracket 8 is sleeved on the housing 1 so that the telescopic bracket 8 reciprocates in the same direction under the action of the telescoping driver 7; a fixed frame 9 is arranged at one end of the housing 1; a mounting notch 10 is provided on the telescopic bracket 8, a patting rod 11 is hingedly mounted in the mounting notch 10, one end of the patting rod 11 forms a patting arm 12, and the other end of the patting rod 11 is connected to the fixed frame 9 by a collar 13; a top end of the telescopic bracket 8 is connected with a beating head 14, and the beating head 14 is embedded in the beating portion 3; the patting arm 12 is embedded in the patting portion 4; the retracting portion 5 is located at a movement track of the telescopic bracket 8. In use for massage, the telescoping driver 7 works to drive the telescopic bracket 8 to move in a reciprocating manner. Because the patting rod 11 is hinged at the mounting notch 10, and the other end of the patting rod 11 is connected to the fixed frame 9 by the collar 13, the fixed frame 9 remains stationary and the patting rod 11 is movable at the hinge point, thereby allowing the patting arm 12 to extend outward. When the telescoping driver 7 retracts, the patting arm 12 is driven to retract inward. Because the patting arm 12 is arranged in the patting portion 4 on the soft rubber sleeve 2, the patting portion 4 which is flexible moves together with the patting arm 12. In this way, the reciprocating movement can simulate a patting massage action. Moreover, when the telescoping driver 7 works, because the beating head 14 embedded in the beating portion 3 is connected to the telescopic bracket 8, the beating head 14 also moves together with the telescopic bracket 8, so that the beating head 14 (beating portion 3) does a telescoping movement to simulate a continuous beating massage action. In order to achieve the telescoping function, the soft rubber sleeve 2 is specially provided with the retracting portion 5 to meet the structural requirements in the telescoping state. The telescoping driver 7 may be a telescoping motor or other driver capable of generating a telescoping driving force.

Further, generally three patting rods are provided. However, when two or more patting rods 11 are provided, the patting rods 11 are arranged in a circular array on the telescopic bracket 8. In this way, the beating points are more evenly distributed, which is conducive to the use of in-body massage.

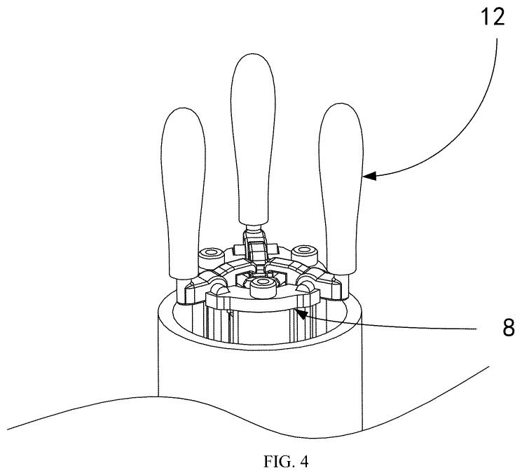

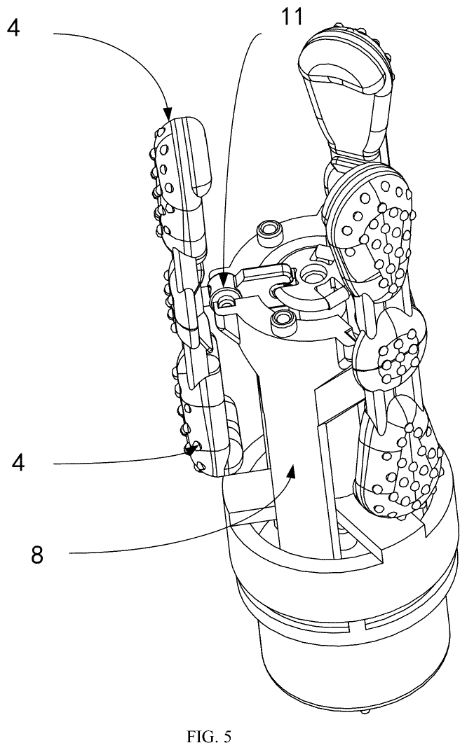

Further, for the design of the patting rod 11, the patting arm 12 may be defined as a single-sided rod or a double-sided rod. As shown in FIGS. 1-4, the patting arm 12 adopts a single-sided rod design; and as shown in FIG. 5, the patting arm 12 adopts a double-sided rod design. When the patting arm is a single-sided rod, the patting arm 12 is oriented upward (FIG. 4) or downward (FIGS. 1-3). Of course, due to the different hinge orientations, the direction of the patting arm may also vary in angle, and the orientation of vertical angle is not the only choice. It should be noted that when the double-sided rod design is used, the patting arm 12 and the patting portion 4 are the same component, and a joint between the patting rod 11 and the patting arm 12 directly extends out of the soft rubber sleeve 2, so that the patting arm 12 and the patting portion 4 are placed outside as an integrated component.

Further, in order to enhance the effect of patting massage, the surface of the patting portion in this embodiment is provided with outwardly protruding patting bumps 15, and the patting bumps 15 may be round, square, heart-shaped, or the like. The specific shape will not be limited here in this embodiment, and it only needs to be changed according to the design.

Further, for the design of the retracting portion 5, the thickness of the retracting portion 5 is less than the thickness of a main body of the soft rubber sleeve 2, and the retracting portion 5 is ripple-like, wavelike or pleated to increase the ductility and elasticity of the retracting portion 5.

Further, in order to ensure the stability of the reciprocating movement of the telescopic bracket 8, the fixed frame 9 in this embodiment is located at the middle part of the telescopic bracket 8, slide grooves 16 are provided on the fixed frame 9, and side plates of the telescopic bracket 8 are respectively placed in the slide grooves 16. In this way, the slide groove 16 can achieve a position limiting function, so that the reciprocating movement is more stable. And the soft rubber sleeve 2 is provided with a patting movement chamber 100 corresponding to the patting portion 4, thereby providing sufficient space for the movement of the patting portion 4.

Further, in order to improve the beating massage intensity and achieve a better massage effect, in this embodiment, a vibrating motor 17 is mounted in the beating head 14 and electrically connected to the main board 6. In this way, the massager can not only simulate the beating massage, but also achieve a vibrating massage effect during the beating massage, thereby presenting a double massage effect.

Further, as for an internal circuit system, the housing 1 in this embodiment is internally equipped with a battery 18 and a key 19 arranged on the main board 6, the battery 18 is electrically connected with the main board 6, and a press portion of the key 19 leans against the inner wall of the soft rubber sleeve 2. The battery 18 is a rechargeable battery, the housing 1 is provided with a charging contact 20, and the soft rubber sleeve 2 is provided with an avoidance position corresponding to the charging contact 20. In this way, the massager can be handheld for use. Moreover, due to the function of charging, the massager can be reused many times, and the design of charging contact is used for a charging plug, thereby achieving a waterproof function.

In addition, in this embodiment, a gripping portion for the user to grip is formed on the housing 1, and the gripping portion is composed of a boss 21 for the thumb to press and an arc-shaped surface 22 for the palm to grip. This design allows users to hold the massager firmly with one hand.

The above is only the preferred embodiment of the present disclosure, and does not therefore limit the scope of the patent of the present disclosure. All the equivalent structure or equivalent process transformations made by using the contents of the specification of the present disclosure and the accompanying drawings, or directly or indirectly applied in other related technical fields, are similarly included in the scope of patent of the present disclosure.

What is claimed is:

1. A telescoping-patting integrated massager, characterized by, comprising a housing and a soft rubber sleeve fitted on the housing, wherein the soft rubber sleeve is provided with a beating portion, a patting portion and a retracting portion; a main board and a telescoping driver electrically connected to the main board are arranged in the housing; a telescopic head of the telescoping driver is connected with a telescopic bracket, and the telescopic bracket is sleeved on the housing so that the telescopic bracket reciprocates in the same direction under the action of the telescoping driver; a fixed frame is arranged at one end of the housing; a mounting notch is provided on the telescopic bracket, a patting rod is hingedly mounted in the mounting notch, one end of the patting rod forms a patting arm, and the other end of the patting rod is connected to the fixed frame by a collar; a top end of the telescopic bracket is connected with a beating head, and the beating head is embedded in the beating portion; the patting arm is embedded in the patting portion; the retracting portion is located at a movement track of the telescopic bracket.

2. The telescoping-patting integrated massager according to claim 1, characterized in that, when two or more patting rods are provided, the patting rods are arranged in a circular array on the telescopic bracket.

3. The telescoping-patting integrated massager according to claim 2, characterized in that, the patting arm of the patting rod is a single-sided rod or a double-sided rod.

4. The telescoping-patting integrated massager according to claim 3, characterized in that, when the patting arm is a single-sided rod, the patting arm is oriented upward or downward.

5. The telescoping-patting integrated massager according to claim 1, characterized in that, a surface of the patting portion is provided with outwardly protruding patting bumps.

6. The telescoping-patting integrated massager according to claim 1, characterized in that, the thickness of the retracting portion is less than the thickness of a main body of the soft rubber sleeve, and the retracting portion is ripple-like, wavelike or pleated.

7. The telescoping-patting integrated massager according to claim 1, characterized in that, the fixed frame is located at the middle part of the telescopic bracket, slide grooves are provided on the fixed frame, side plates of the telescopic bracket are respectively placed in the slide grooves, and the soft rubber sleeve is provided with a patting movement chamber corresponding to the patting portion.

8. The telescoping-patting integrated massager according to claim 1, characterized in that, a vibrating motor is mounted in the beating head and electrically connected to the main board.

9. The telescoping-patting integrated massager according to claim 1, characterized in that, a gripping portion for a user to grip is formed on the housing, and the gripping portion is composed of a boss for the thumb to press and an arc-shaped surface for the palm to grip.

10. The telescoping-patting integrated massager according to claim 1, characterized in that, the housing is internally equipped with a battery and a key arranged on the main board, the battery is electrically connected with the main board, and a press portion of the key leans against the inner wall of the soft rubber sleeve; the battery is a rechargeable battery, the housing is provided with a charging contact, and the soft rubber sleeve is provided with an avoidance position corresponding to the charging contact.
